(19) United States
(12) Patent Application Publication
(10) Pub. No.: US 2025/0259368 A1
(43) Pub. Date: Aug. 14, 2025

(54) GENERATING AND PROVIDING VISUAL CONTENT ITEMS FOR DISPLAY

(71) Applicant: Roku, Inc., San Jose, CA (US)

(72) Inventors: Charles Brian Pinkerton, Boulder, CO (US); Sunil Ramesh, Saratoga, CA (US); Michael Patrick Cutter, Golden, CO (US); David Lee Stern, Los Gatos, CA (US); Andrew Peter Fogg, Los Gatos, CA (US)

(73) Assignee: Roku, Inc., San Jose, CA (US)

(21) Appl. No.: 18/438,946

(22) Filed: Feb. 12, 2024

(51) Int. Cl. G06T 15/00; G06F 3/01; G06T 19/00

(52) U.S. Cl. CPC G06T 15/00; G06F 3/011; G06T 19/003

(57) ABSTRACT

A visual content item may be created to illustrate a visual scene. Dimensions of the visual scene may be determined. A dimension may be a spatial dimension or a temporal dimension. A viewpoint in the virtual scene may be determined. One or more visual objects may be generated. based on the request, dimensions of the visual scene, and the viewpoint. The visual content items may be generated building the visual scene with the one or more visual objects. The request may include a pre-generated visual content item (e.g., an image, video, etc.), and the visual content item may be created based on the pre-generated visual content item, e.g., by changing one or more dimensions or viewpoints associated with the pre-generated visual content item. The visual content item may be transmitted to a client device associated with a user, the client device to display the visual content item to the user.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

Figure (FIG.) 1 illustrates a visual content environment, according to some embodiments of the present disclosure;

FIG. 2 is a block diagram showing a visual content system, according to some embodiments of the present disclosure;

FIG. 3 is a block diagram showing a visual content generator, according to some embodiments of the present disclosure;

FIG. 4 shows an example visual content item illustrating a visual scene, according to some embodiments of the present disclosure;

FIG. 5 shows an example visual content item generated based on the visual content item in FIG. 4, according to some embodiments of the present disclosure;

FIG. 6 shows another example visual content item generated based on the visual content item in FIG. 4, according to some embodiments of the present disclosure;

FIG. 7 shows a visual content item having more dimensions than the visual content item in FIG. 6, according to some embodiments of the present disclosure;

FIG. 8 shows a visual content item having a different viewpoint from the visual content item in FIG. 4, according to some embodiments of the present disclosure;

FIG. 9 is a flowchart showing a method of providing visual content items for display to users, according to some embodiments of the present disclosure; and

FIG. 10 is a block diagram of an example computing device, in accordance with various embodiments.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

Visual content is any type of content that is image-based. Visual content may be or include multimedia content, such as a combination of image signa, audio signal, and so on. A visual content item may include one or more images or one or more videos. A visual content item has at least one visual element, which may illustrate an object using a visual representation of the object. A visual content item may also have one or more non-visual elements, such as audio-based elements, text-based elements, and so on. Compared with purely text-based content or purely audio-based content, visual content can be more engaging and have more entertainment value.

Embodiments of the present disclosure provide systems and methods for generating visual content items and providing visual content items for display to users. A visual content item may include one or more images or videos. Additionally, the visual content item may include audio or other types of data. A visual content item may illustrate a scene and include visual representations of objects in the scene. The scene may be a real-world scene, a virtual scene, or an augmented scene. Examples of objects include people, buildings, streets, vehicles, trees, plants, furniture, appliances, and so on. The objects may include real-world objects or virtual objects.

In various embodiments of the present disclosure, a visual content system may be in communication with one or more user devices associated with users of the visual content system. The visual content system may also in communication with one or more third-party systems. The visual content system may generate visual content items based on requests for visual content. Such requests may be received from user devices, third-party systems, or a combination of both. For example, a user may request a visual content item that the user wants to view. As another example, an entity may request a visual content item that the entity wants users of the visual content system to view. To create a visual content item, the visual content system may generate one or more visual objects based on a theme (e.g., the scene to be illustrated by the visual content item), dimensions of the visual content item, viewpoints associated with the visual content item, other factors, or some combination thereof.

The visual content system may determine the theme based on information in the request for visual content (if any), user interest, other information, or some combination thereof. The visual content system may determine what types of visual objects to be included in the visual content item based on the theme. The visual content system may also generate a visual object based on the dimensions of the visual content items. For instance, the visual content system may generate 2D visual objects for a 2D visual content item, versus generate 3D visual objects for a 3D visual content item. In embodiments where the visual content item has a temporal dimension, the visual content system may generate dynamic visual objects, the states of which may change with time. The visual content system may also generate visual objects based on a viewpoint generated for the visual content item. As the viewpoint changes, the scene may be different and visual objects for illustrating the scene may be different. In some embodiments, the visual content system may generate visual content items by modifying dimensions or viewpoints of pre-generated visual content items.

A visual object may have one or more interactive elements that allow users to interact with the visual content item. The visual content system may log user actions with visual content items. The visual content system may also receive information of user actions in other systems, e.g., third-party systems. The visual content system may infer user interests for visual content items based on such user actions. Also, the visual content system may allow users to express interests. Additionally or alternatively, the visual content system may determine user interests based on sensor data from user devices, e.g., sensor data that captures users' facial expressions or eye movements while the users are viewing visual content items.

As will be appreciated by one skilled in the art, aspects of the present disclosure, in particular aspects of visual content generation, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive or and not to an exclusive or.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

### Visual Content System

FIG. 1 illustrates a visual content environment 100, in accordance with various embodiments. The visual content environment 100 includes a visual content system 110, a third-party system 120, and a plurality of user devices 130 (individually referred to as user device 130). The visual content system 110, third-party system 120, and user devices 130 are coupled to a network 105. In other embodiments, the visual content environment 100 may include fewer, more, or different components. For instance, the visual content environment 100 may include more than one visual content system 110 or a different number of user devices 130. Functionality attributed to a component of the visual content environment 100 may be accomplished by a different component included in the visual content environment 100 or by a different device or system.

The visual content system 110 provides visual content items for display to users, e.g., through the user devices 130. A visual content item may include one or more images, videos, audios, content in other formats, or some combination thereof. A visual content item may be or may be included in a movie, video game, television show, and so on. In some embodiments, a visual content item may illustrate a scene and include visual representations of objects in the scene. The visual content item may illustrate the scene from one or more viewpoints. The scene or an object in the scene may have multiple dimensions. A dimension can be a spatial dimension or a temporal dimension. For instance, a visual content item may include two-dimensional (2D) objects, three-dimensional (3D objects), four-dimensional (4D) objects, and so on. A 2D object may have two spatial dimensions. A 3D object may have three spatial dimensions. A 4D object may have three spatial dimensions plus a temporal dimension. For instance, one or more attributes of the 4D object may change with time. The attributes may include orientation, location, shape, color, size, state and so on. Visual representations of objects may be computer-generated visual representations.

The visual content system 110 may generate visual content items based on existing visual content items, user requests, textual descriptions of scenes, and so on. In an example, the visual content system 110 may augment an existing visual content item by adding one or more dimensions of the existing visual content item, changing a viewpoint of the existing visual content item, adding or modifying one or more objects in the existing visual content item, and so on. The visual content system 110 may distribute visual content items to other devices or systems, such as the user devices 130, so that the visual content items can be presented to users. Some objects in the visual content items may be associated with a third party, e.g., a third party associated with the third-party system 120. For instance, an object may be provided by the third party or be requested by the third party for displaying to the users.

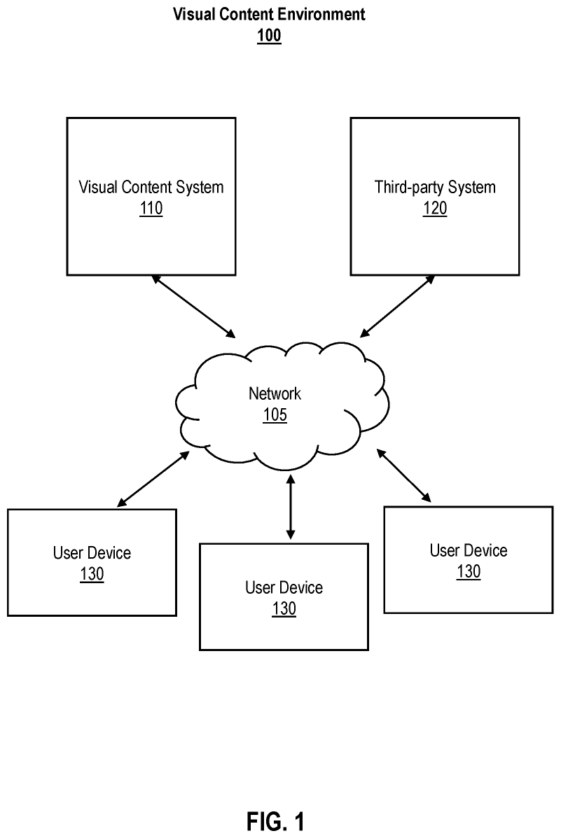

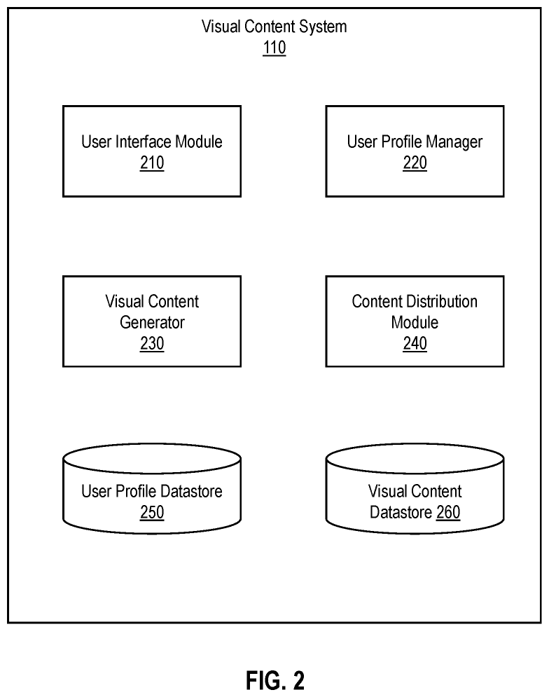

In some embodiments, the visual content system 110 may facilitate web pages that users can visit by using the user devices 130. Additionally or alternatively, the visual content system 110 may provide application programming interface (API) functionality to send data to operating systems of the user devices 130. Users can interact with the visual content system 110 through the web pages or the API functionality. For instance, users may make requests for visual content items to the visual content system 110 or view visual content items provided by the visual content system 110 through the web pages or the API functionality. Certain aspects of the visual content system 110 are described below in conjunction with FIG. 2.

The third-party system 120 may be an application provider communicating information describing applications for execution by a user device 130 or communicating data to user devices 130 for use by an application executing on the user device 130. In other embodiments, a third-party system 120 provides content or other information for presentation via a user device 130. A third-party system 120 may also communicate information to the visual content system 110, such as advertisements, content, or information about an application provided by the third-party system 120, and so on.

In some embodiments, the third-party system 120 is an online system maintained by a third party, which may be a source of visual content items, a supplier of products (e.g., merchandise, etc.), a service provider, and so on. For example, the third-party system 120 may provide visual content items to the visual content system 110 or the user devices 130. As another example, the third-party system 120 may facilitate an e-commerce system (e.g., an e-commerce website) that facilitates buying and selling of goods or services online. The third-party system 120 may provide one or more software applications to the user devices 130. The software applications can be downloaded and installed onto the user devices 130 for users associated with the user devices 130 to interact with content items provided by the third-party system 120. For instance, the users can view content items, comment on content items, share content items, or make purchases through the software applications.

In some embodiments, the third-party system 120 may recognize a user of the visual content system 110 through an online plug-in enabling the third-party system 120 to identify the user of the visual content system 110. Users of the visual content system 110 may be uniquely identifiable, and the third-party system 120 may communicate information about a user's actions outside of the visual content system 110 to the visual content system 110 for association with the user. That way, the visual content system 110 can record information about actions users perform on the third-party system 120, including webpage playing histories, advertisements that were interacted, purchases made, and other patterns from shopping and buying. Additionally, actions a user performs via an application associated with third-party system 120and executing on a user device 130 may be communicated to the visual content system 110 by the application for recordation and association with the user.

The user devices 130 are one or more computing devices capable of receiving user input as well as transmitting and/or receiving data via the network 105. In one embodiment, a user device 130 is a conventional computer system, such as a desktop or a laptop computer. Alternatively, a user device 130 may be a device having computer functionality, such as a personal digital assistant (PDA), a mobile telephone, a smartphone, a headset (e.g., virtual reality headset, augmented reality headset, etc.), or another suitable device. A user device 130 is configured to communicate via the network 105. In one embodiment, a user device 130 executes an application allowing a user of the user device 130 to interact with the online system 140. For example, a user device 130 executes a browser application to enable interaction between the user device 130 and the online system 140 via the network 105. In another embodiment, a user device 130 interacts with the online system 140 through an application programming interface (API) running on a native operating system of the user device 130, such as IOS® or ANDROID™. In some embodiments, a user device 130 executes a software module that plays videos. The software module allows the user to play, pause, or leave a video.

A user device 130 may execute one or more applications allowing a user of the user device 130 to interact with the third-party system 120. For example, a user device 130 executes a browser application to enable interaction between the user device 130 and the third-party system 120. In another embodiment, a user device 130 interacts with the third-party system 120 through an application programming interface (API) running on a native operating system of the user device 130, such as IOS® or ANDROID™. The user device 130 may allow its user(s) to interact with the third-party system 120, e.g., through one or more user interfaces supported by the third-party system 120. For example, a user may specify a request for generating content (“content generation request”) and may receive the requested content from the third-party system 120. As another example, the third-party system 120 can develop one or more content generation applications based on information provided by a user.

In some embodiments, a user device 130 is an integrated computing device that operates as a standalone network-enabled device. For example, the user device 130 includes display, speakers, microphone, camera, and input device. In another embodiment, a user device 130 is a computing device for coupling to an external media device such as a television or other external display and/or audio output system. In this embodiment, the user device 130 may couple to the external media device via a wireless interface or wired interface (e.g., an HDMI (High-Definition Multimedia Interface) cable) and may utilize various functions of the external media device such as its display, speakers, microphone, camera, and input devices. Here, the user device 130 may be configured to be compatible with a generic external media device that does not have specialized software, firmware, or hardware specifically for interacting with the user device 130.

In some embodiments, the user device 130 may include or be associated with one or more sensors. The sensors may detect objects in an environment around the user device 130. For instance, a sensor may detect facial expression or eye gaze of the user. In some embodiments, the sensors may include cameras having different views, e.g., a front-facing camera, a back-facing camera, and side-facing cameras. One or more sensors may be implemented using a high-resolution imager with a fixed mounting and field of view. One or more sensors may have adjustable field of views and/or adjustable zooms. In some embodiments, a sensor may operate continually during operation of the user device 130, e.g., during the display of visual content items by the user device 130. A sensor may operate in accordance with an instruction from the user or from the visual content system 110. For instance, the visual content system 110 may request the user device 130 to detect the user's facial expression or track the user's eyes while the user is viewing a visual content item provided by the visual content system 110. The visual content system 110 may allow the user to opt-in or opt-out to have the sensors of the user device 130 detect the user's facial expression or track the user's eyes during display of visual content items.

The network 105 supports communications among the visual content system 110, the third-party system 120, and the user devices 130. The network 105 may comprise any combination of local area and/or wide area networks, using both wired and/or wireless communication systems. In one embodiment, the network 105 may use standard communications technologies and/or protocols. For example, the network 105 may include communication links using technologies such as Ethernet, 1010.11, worldwide interoperability for microwave access (WiMAX), 3G, 4G, code division multiple access (CDMA), digital subscriber line (DSL), etc. Examples of networking protocols used for communicating via the network 105 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 105 may be represented using any suitable format, such as hypertext markup language (HTML) or extensible markup language (XML). In some embodiments, all or some of the communication links of the network 105 may be encrypted using any suitable technique or techniques.

FIG. 2 is a block diagram showing the visual content system 110, according to some embodiments of the present disclosure. In the embodiments of FIG. 2, the visual content system 110 includes a user interface module 210, a user profile manager 220, a visual content generator 230, a content distribution module 240, a user profile datastore 250, and a visual content datastore 260. In other embodiments, the visual content system 110 may include fewer, more, or different components. Functionality attributed to a component of the visual content system 110 may be accomplished by a different component included in the visual content system 110 or by a different device or system.

The user interface module 210 provides interfaces to user devices, including the user devices 130 in FIG. 1. Examples of the user devices include headsets, smartphones, tablets, computers, and so on. For example, the user interface module 210 may provide one or more apps or browser-based interfaces that can be accessed by users associated with the user devices. The user interface module 210 may enable the users to submit requests for visual content to the visual content system 110. The user interface module 210 may enable a user to specify attributes of a visual content item that the user requests. Example attributes of a visual content item may include a scene illustrated by the visual content item, a theme of the visual content item, one or more objects to be included in the visual content item, temporal length of the visual content item, and so on.

In some embodiments, the user interface module 210 provides interfaces for users to provide the users' information to the visual content system 110, such as identifying information, declarative information, user interest information, and so on. The user interface module 210 may enable users to select privacy settings. The user interface module 210 may enable a user to opt-in to share some, all, or none of the user's information with other users or third-parties. The user interface module 210 may further enable the user to opt-in to certain tracking features, e.g., to opt-in to have the visual content system 110 track information of the user's actions on the third-party system 120. The user interface module 210 may explain how this data is used by the visual content system 110 and may enable users to selectively opt-in to certain privacy protection features, or to opt-out of all of the privacy protection features. The user interface module 210 may also enable users to select viewing settings. For instance, he

The user profile manager 220 maintains and manages profiles of users of the visual content system 110. In some embodiments, each user of the visual content system 110 is associated with a user profile. A user profile may include identifying information of the user, such as name, user ID, email address, phone number, mailing address, and so on. A user profile may also include descriptive information about the user, such as work experience, educational history, gender, hobbies or preferences, location, and so on. Information in the user profile may be explicitly shared by the user. Additionally or alternatively, the user profile may include information inferred by the user profile manager 220. A user profile may also store other information provided by the user, such as images, videos, audios, textual documents, and so on.

In some embodiments, the user profile manager 220 may maintain references to actions historical actions that a user has performed on visual content items provided by the visual content system 110, such as viewing, commenting on, sharing, skipping, deleting, and so on. The user profile manager 220 may also maintain references to actions performed by the user on the third-party system 120 or other systems. In some embodiments, the user profile manager 220 may log actions of the user and store information of the user's actions in the user profile of the user.

In some embodiments, the user profile manager 220 stores user profiles in the user profile datastore 250. While user profiles in the user profile store 205 are frequently associated with individuals, user profiles may also be stored for entities such as businesses or organizations. An example of the entities may be an entity associated with the third-party system 120. An entity may request the visual content system 110, e.g., through the user interface module 210, to provide visual content items advertising its products or provide other information to users of the online system 140. In some embodiments, the entity's request may include information identifying audience of the visual content items. For instance, a request for visual content from the entity may specify one or more attributes (e.g., location, work experience, interests, etc.) of the target audience of the visual content item.

The user profile manager 220 may further infer the user's preferences or interests for visual content items based on information in the user profile, such as descriptive information of users, historical actions of users, and so on. In some embodiments, the user profile manager 220 may use a machine learning model to learn user interests based on user profiles. For example, the user profile manager 220 may input information of a user in the corresponding user profile into the machine learning model, and the machine learning model outputs one or more classifications of visual content items that the user is interested in.

The user profile manager 220 may include or be associated with a training module that trains the machine learning model with machine learning techniques. As part of the generation of the model, the training module may form a training set. The training set may include training samples and ground-truth labels of the training samples. A training sample may include user profiles of users. The training sample may have one or more ground-truth classifications of visual content items the users are interested in. For instance, the users have explicitly or implicitly confirmed that they are interested in visual content items in the ground-truth classification(s). The training module extracts feature values from the training set, the features being variables deemed potentially relevant to classification of visual content items that the users are interested in. In one embodiment, the training module applies dimensionality reduction (e.g., via linear discriminant analysis (LDA), principal component analysis (PCA), or the like) to reduce the amount of data in the feature vectors (e.g., feature vectors of user profiles, feature vectors of visual content items, and so on) to a smaller, more representative set of data. The training module may use supervised machine learning to train the model. Different machine learning techniques—such as linear support vector machine (linear SVM), boosting for other algorithms (e.g., AdaBoost), neutral networks, logistic regression, naïve Bayes, memory-based learning, random forests, bagged trees, decision trees, boosted trees, or boosted stumps—may be used in different embodiments.

The visual content generator 230 generates visual content items that may be provided for display to users of the visual content system 110. A visual content item may include one or more visual objects. Visual objects may be visual representations of objects, such as people, buildings, streets, vehicles, trees, plants, furniture, appliances, and so on. The objects may include real-world objects or virtual objects. To create a visual content item, the visual content generator 230 may generate one or more visual objects based on the theme of the visual content item, dimensions of the visual content item, viewpoint of the visual content item, other factors, or some combination thereof.

In some embodiments, the visual content generator 230 may first determine the theme of the visual content item, e.g., the scene to be illustrated by the visual content item. The visual content generator 230 may determine the theme based on information in the request for visual content (if any) or based on user interest. The visual content generator 230 may determine what types of visual objects to be included in the visual content item based on the theme. The visual content generator 230 may generate a visual object based on the dimensions of the visual content items. For instance, the visual content generator 230 may generate 2D visual objects for a 2D visual content item, versus generate 3D visual objects for a 3D visual content item. In embodiments where the visual content item has a temporal dimension, the visual content generator 230 may generate dynamic visual objects, which may change with time. The visual content generator 230 may also generate visual objects based on a viewpoint of the visual content item. As the viewpoint changes, the visual objects may be different. The visual content generator 230 may generate visual objects that are compatible with multiple viewpoints so that the viewpoint of the visual content item can be changed.

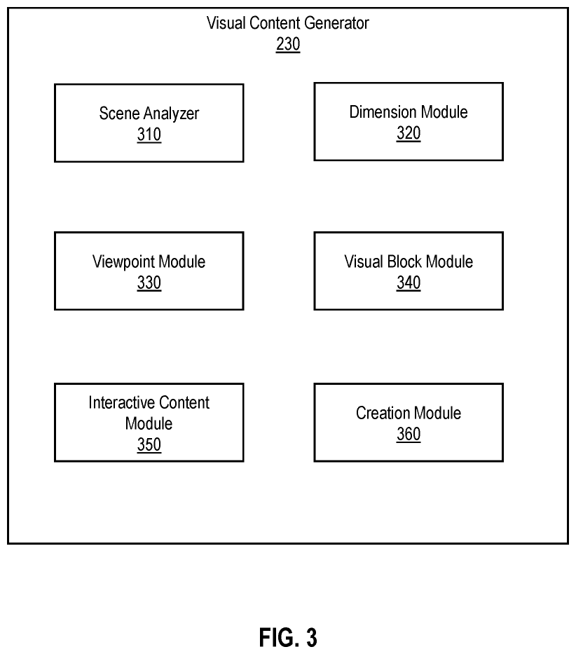

Visual content items generated by the visual content generator 230 may be stored in the visual content datastore 260. In some embodiments, the visual content generator 230 may generate a visual content item from scratch. In other embodiments, the visual content generator 230 may generate a visual content item based on an existing visual content item, e.g., by changing dimensions or viewpoint of the existing visual content item. In yet other embodiments, the visual content generator 230 may generate a visual content item with one or more pre-generated visual blocks. Certain aspects of the visual content generator 230 are described below in conjunction with FIG. 3.

The content distribution module 240 distributes visual content items to users of the visual content system 110. In some embodiments, the content distribution module 240 may distribute a visual content item to the user who requested the visual content item. The user may have an online account with the visual content system 110. The content distribution module 240 may make the visual content item available in the user's online account for the user to view. In addition to visual content items requested by the user, the content distribution module 240 may provide other visual content items (e.g., visual content items requested by other users, etc.) to the user. The content distribution module 240 may rank visual content items accessible by a user, e.g., based on affinities of the visual content items with the user. The content distribution module 240 may the affinity of a visual content item with the user based on the user's interest (e.g., user interest determined by the user profile manager 220), attributes of the visual content item (e.g., a timestamp associated with the visual content item, popularity of the visual content item, etc.), relationship between the visual content item and the user (e.g., whether the visual content item is requested by the user), other factors, or some combination thereof.

In other embodiments, the content distribution module 240 may distribute a visual content item to one or more users who are different from the user who requested the visual content item. For instance, the content distribution module 240 may distribute a visual content item including an advertisement to a target audience of the advertisement. A visual content item including an advertisement may be requested by an entity user of the visual content system 110, e.g., a third party associated with the third-party system 120. The entity user may also include information of the target audience in the request for visual content. The content distribution module 240 may find the target audience by selecting users of the visual content system 110 based on the request for visual content. The content distribution module 240 may distribute the visual content including the advertisement to the selected users.

FIG. 3 is a block diagram showing the visual content generator 230, according to some embodiments of the present disclosure. In the embodiments of FIG. 3, the visual content generator 230 includes a scene analyzer 310, a dimension module 320, a viewpoint module 330, a visual block module 340, and an interactive content module 350. In other embodiments, the visual content generator 230 may include fewer, more, or different components. Functionality attributed to a component of the visual content generator 230 may be accomplished by a different component included in the visual content generator 230 or by a different device or system.

The scene analyzer 310 determines scenes to be illustrated by visual content items. For instance, the scene analyzer 310 may determine a theme of a visual content item and then determine the scene to be illustrated by the visual content item based on the determined theme. The scene analyzer 310 may receive information from another system or device, such as the third-party system 120 or a user device 130 and determine the theme of the scene based on the received information. In some embodiments, the scene analyzer 310 may receive a request for visual content from the third-party system 120 or a user device 130, and the request for visual content may include information indicating a scene. In an example, a request for content item may be specify a movie or a video game, and the scene analyzer 310 may determine the scene based on content of the movie or video game.

In another example, the request for visual content may include a textual document that includes a description of a scene. The scene analyzer 310 may perform language processing on the textual document to determine the scene. For instance, the scene analyzer 310 may perform language process on the textual document to determine a theme of the scene, one or more types of objects to be included in the scene, states (e.g., movements, actions, orientations, etc.) of objects in the scene, relationships between different objects in the scene, other information about the scene, or some combination thereof. In an embodiment, the language processing may be semantic analysis. In another embodiment, the scene analyzer 310 may input the textual document into a language model (e.g., a large language model (LLM), and the language model may output the scene described in the textual document.

In some embodiments, the scene analyzer 310 may determine scenes of visual content items based on user interests. The scene analyzer 310 may determine whether a user requesting a visual content item has expressed any particular interest with respect to what is to be illustrated by the visual content item. For instance, the user may indicate that the visual content item is for showing an advertisement. The scene analyzer 310 may determine the theme of the scene based on the product or service of the advertisement. In embodiments where the scene analyzer 310 determines that the user has not expressed any particular interest with respect to what is to be illustrated by the visual content item, the scene analyzer 310 may infer the user's interest, e.g., based on the corresponding user profile, viewing history of the user, actions performed by the user on other systems (e.g., the third-party system 120), and so on.

The dimension module 320 may determine dimensions of scenes determined by the scene analyzer 310. For instance, the dimension module 320 may determine whether a scene should be 2D, 3D, or 4D. In some embodiments, the dimension module 320 may determine dimensions of the scene to be illustrated by a visual content item based on the corresponding request for visual content. The request for visual content may specify the number of dimensions that the user would like the visual content item to have. Additionally or alternatively, the dimension module 320 may determine dimensions of the scene to be illustrated by a visual content item based on the user device 130 that will display the visual content item. For instance, the dimension module 320 may receive, e.g., from the user device 130, information of computational power, network bandwidth, or display capabilities of the user device 130 and determine the number of dimensions of the visual content item based on the information to ensure that the user device 130 will be able to display the visual content item, e.g., without significant latency, etc.

The dimension module 320 may also determine dimensions of the scene to be illustrated by a visual content item based on based on user interests. For instance, the user may indicate that the visual content item is for placing an avatar of the user into a video game, and the scene analyzer 310 may determine that the visual content item should have a temporal dimension. In embodiments where the scene analyzer 310 determines that the user has not expressed any particular interest with respect to dimension of the visual content item, the scene analyzer 310 may infer the user's interest, e.g., based on the corresponding user profile, viewing history of the user, actions performed by the user on other systems (e.g., the third-party system 120), and so on.

The viewpoint module 330 determines viewpoints from which scenes to be illustrated by visual content items are perceived. In some embodiments, the viewpoint module 330 may determine one viewpoint for a scene. In other embodiments, the viewpoint module 330 may determine multiple viewpoints for a scene. The visual content item, after being created, may illustrate the scene from all the viewpoints. Such a visual content item is a multi-view visual content item. Multi-view visual content items may achieve multi-view stereoscopic display. A user may be allowed to select one of the viewpoints to view the scene from the selected viewpoint. As the viewpoint changes, the multi-view visual content item may illustrate different objects in the scene or illustrate the same objects from a different angle.

The viewpoint module 330 may determine real viewpoints, virtual viewpoints, or a combination of both. A real viewpoint may be a viewpoint in a real-world scene, e.g., a real-world environment that a person can perceive using the person's own senses. A real viewpoint may be a viewpoint of a sensor (e.g., camera, LiDAR (light detection and ranging) sensor, etc.) that captures an image or video of a real-world scene. A virtual viewpoint may be a viewpoint in a virtual scene. A virtual scene may be an artificial, computer-generated environment that permits viewers to interact with the environment as if the viewers are immersed in the environment. A virtual scene is not captured by a camera or other types of sensors.

A real viewpoint or virtual viewpoint may also be a viewpoint in an augmented scene. An augmented scene is a combination of a real-world scene and a virtual scene. The augmented scene includes one or more real-world objects and one or more virtual objects. The virtual objects augment the real-world scene. The real-world objects may be integrated with the virtual objects. For example, an augmented scene may include real-world streets and buildings in addition to computer-generated, virtual racing cars “driving” on the real-world streets. In some embodiments, the viewpoint module 330 may generate a virtual viewpoint based on depth information of the corresponding scene, e.g., a depth model or a depth map of the scene. For instance, depth-image-based rendering may be used to generate virtual viewpoints.

In some embodiments, the viewpoint module 330 may generate a viewpoint for a visual content item based on the corresponding request for visual content. For instance, the viewpoint module 330 may generate a viewpoint specified in the request for visual content. Additionally or alternatively, the viewpoint module 330 may determine user interests for viewpoints and generate viewpoints that meet the user interests. The viewpoint module 330 may learn a user's interest for one or more viewpoints based on the user's profile, viewing history, the user's actions in other systems (e.g., the third-party system 120), other data, or some combination thereof. In some embodiments (e.g., embodiments where a user requests a visual content item including a visual representation of the user itself), the viewpoint module 330 may generate one or more viewpoints based on the visual representation of the user. For instance, the viewpoint module 330 may determine one or more gaze points of the visual representation of the user and generate viewpoints corresponding to the gaze points. A gaze point of the visual representation of the user may be determined based on tracking of the eyes of the user in real world.

The visual block module 340 builds visual blocks that can be used to create visual content items. A visual block may be a visual representation of one or more objects. A visual block may be used as an element to build visual scenes. For instance, multiple visual blocks may be combined and integrated to build a visual scene. The same visual block may be used to build multiple, different visual scenes. As visual blocks can be reused, the efficiency of the visual content generator 230 can be improved. For instance, computational resources, power, time, or other types of resources may be saved. In some embodiments, the visual block module 340 may generate one or more visual blocks to be used to create a visual content item before the visual content item is requested. Visual blocks may be stored in the visual content datastore 260.

In some embodiments, the visual block module 340 may associate one or more tags with a visual block. Tags may specify information of visual blocks, such as types of objects illustrated by the visual blocks, dimensions, viewpoints associated with the visual blocks, classifications, colors, shapes, orientations, depth information, and so on. The visual block module 340 may maintain a searchable database of visual blocks. A visual block may be identified based on a tag of the visual block.

The interactive content module 350 generates interactive elements that may be included in visual content items. In some embodiments, the interactive content module 350 may generate an interactive visual block. In other embodiments, the interactive content module 350 may modify a pre-generated visual block with one or more interactive elements. Interactive elements are elements on which a user may perform actions. For instance, an interactive element may allow the user to enter input, provide a reaction, click to get additional information, and so on. In an example, an interactive element may be embedded with a link (e.g., a uniform resource location (URL)) of a web page, e.g., a web page maintained by the third-party system. A user may be directed to the web page from the visual content item after the user clicks the link. In another example, an interactive element may provide additional information to the user in response to the user's interaction with the interactive element. The additional information may be presented to the user in a dropdown list, a text box, and so on. Interactive elements may be stored in the visual content datastore 260.

The creation module 360 may create visual content items based on scenes determined by the scene analyzer 310, dimensions determined by the dimension module 320, viewpoints generated by the viewpoint module 330, visual blocks generated by the visual block module 340, interactive elements generated by the interactive content module 350, other data, or some combination thereof. In some embodiments (e.g., embodiments where visual blocks are used), the creation module 360 may search for visual blocks stored in the visual content datastore 260, e.g., based on the scene determined by the scene analyzer 310. The creation module 360 may determine what types of objects would be needed for illustrating the scene generate one or more search terms to search for visual blocks illustrating such objects. The creation module 360 may also generate one or more search terms based on dimensions of the scene determined by the dimension module 320 or a viewpoint of the scene determined by the viewpoint module 330.

In some embodiments, after the creation module 360 identifies a visual block, the creation module 360 may modify the visual block. In an example, the creation module 360 may remove a dimension from the visual block or add a dimension to the visual block. In another example, the creation module 360 may modify the visual block based on a viewpoint generated by the viewpoint module 330, and the modified visual block would illustrate a perception of the corresponding object from the viewpoint. In yet another example, the creation module 360 may modify a visual block by adding one or more interactive elements to the visual block.

In other embodiments (e.g., embodiments where the creation module 360 does not find any building blocks fitting the scene), the creation module 360 may build at least part of the visual content item from scratch. Alternatively, the creation module 360 may instruct the visual block module 340 to build new visual blocks for the scene. Visual content items generated by the creation module 360 may be distributed to one or more users of the visual content system 110 by the content distribution module 240 or be stored in the visual content datastore 260.

### Example Visual Content Items

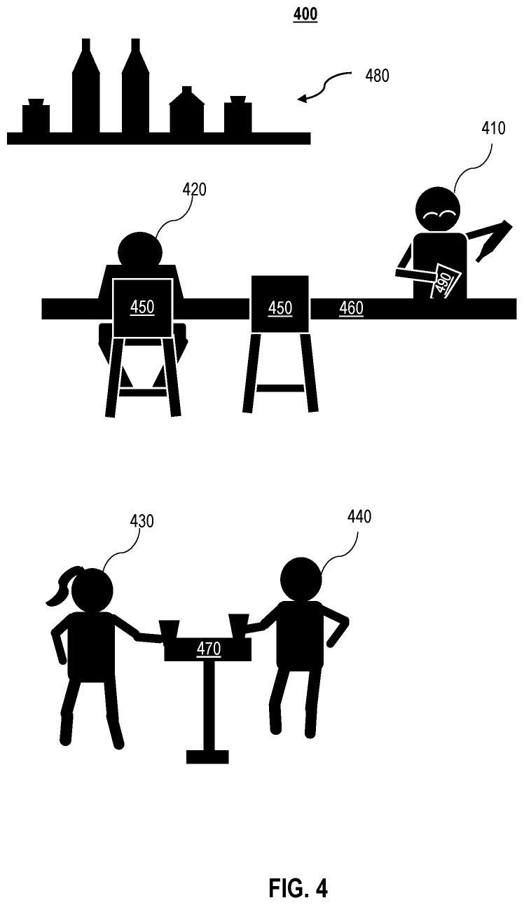

FIG. 4 shows an example visual content item 400 illustrating a visual scene, according to some embodiments of the present disclosure. In some embodiments, the visual content item 400 may be generated by the visual content generator 230. In other embodiments, the visual content item 400 may be received by the visual content generator 230, e.g., from the third-party system 120, a user device 130, or other devices or systems. An example of the visual content item 400 may be a video or part of a video, e.g., a movie, TV series, video game, cartoon, and so on. Other examples of the visual content item 400 may include photograph, image, drawings, and so on.

For the purpose of illustration, the visual content item 400 in FIG. 4 illustrates a scene of a bar that has a bartender 410 and three other people 420, 430, and 440. The visual content item 400 also illustrates chairs 450, tables 460 and 470, a drink rack 480, and cups 490 (individually referred to as “cup 490”). In other embodiments, the visual content item 400 may show different, fewer, or more objects. In some embodiments, some or all of the objects in the visual content item 400 may be pre-generated visual blocks. The visual content item 400 may be created by integrating the visual blocks. Even though the visual content item 400 is shown as a 2D visual content item in FIG. 4, the visual content item 400 may be 3D or 4D.

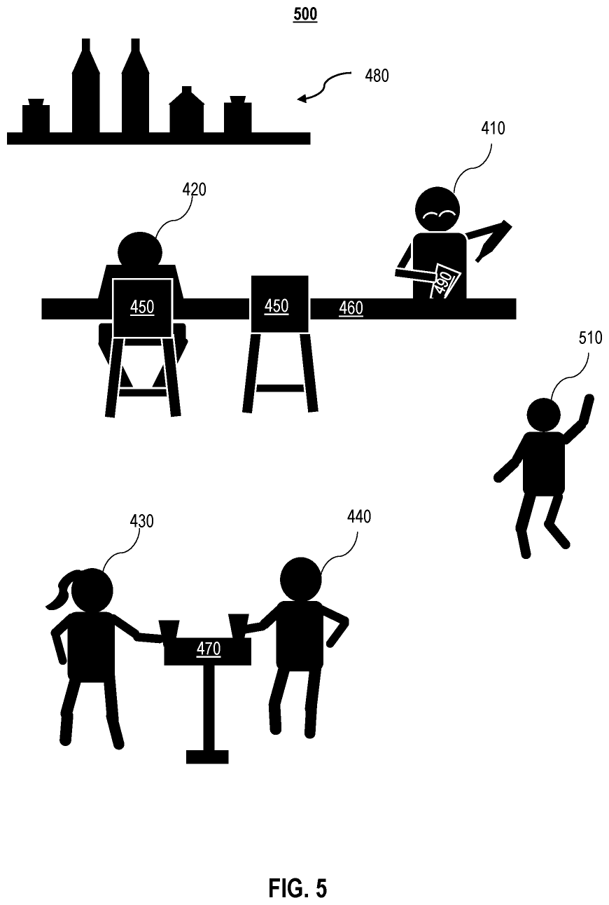

FIG. 5 shows an example visual content item 500 generated based on the visual content item 400 in FIG. 4, according to some embodiments of the present disclosure. The visual content item 500 may be generated by the visual content generator 230. For the purpose of illustration, the visual content item 500 is generated by adding an avatar 510 into the visual content item 400. The avatar 510 is a visual representation of a person. In other embodiments, different or more objects may be added to the visual content item 400.

In some embodiments, the visual content generator 230 may add the avatar 510 to the visual content item 400 based on a request for content item. For instance, a user may request to add an avatar of him or her to the visual content item 400. In response to the request, the visual content generator 230 may generate an avatar of the user and modify the visual content item 400 accordingly. The visual content generator 230 may allow the user to provide specifications of the avatar 510, such as hair style, clothes, facial features, and so on. The visual content generator 230 may generate the avatar 510 based on the information provided by the user.

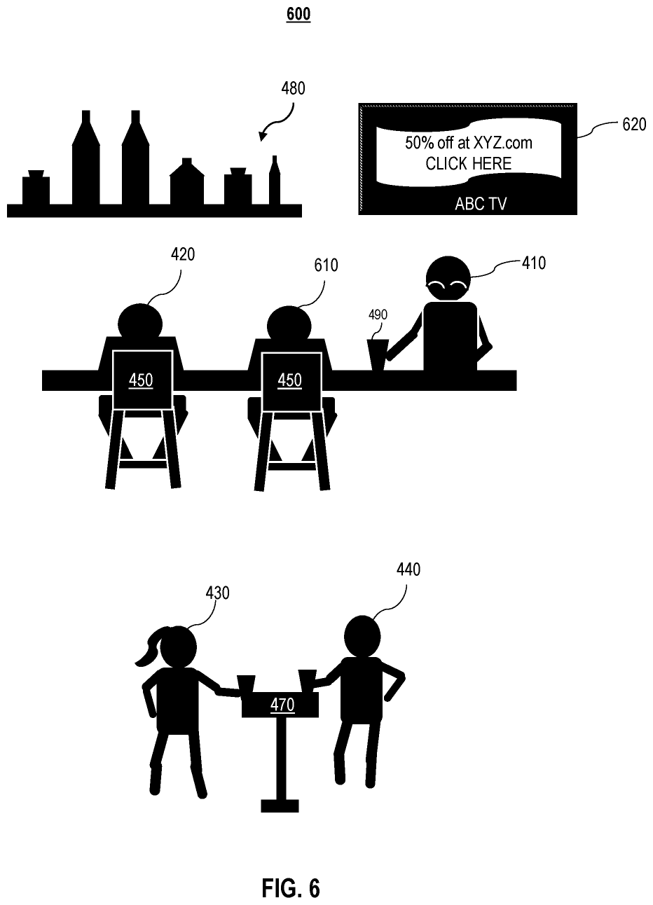

FIG. 6 shows another example visual content item 600 generated based on the visual content item 400 in FIG. 4, according to some embodiments of the present disclosure. The visual content item 600 may be generated by the visual content generator 230. For the purpose of illustration, the visual content item 600 is generated by adding an avatar 610 and a virtual TV 620 into the visual content item 400. In other embodiments, different or more objects may be added to the visual content item 400.

In some embodiments, the visual content generator 230 may add the avatar 610 to the visual content item 400 based on a request for content item. For instance, a user may request to add an avatar of him or her to the visual content item 400. In response to the request, the visual content generator 230 may generate an avatar of the user and modify the visual content item 400 accordingly. The visual content generator 230 may allow the user to provide specifications of the avatar 610, such as hair style, clothes, facial features, and so on. The visual content generator 230 may generate the avatar 610 based on the information provided by the user.

The virtual TV 620 may be added to the visual content item 400 based on a request for visual content made by a third party, which may be a different party from the visual content system 110 or from the users who view the visual content item 600. For instance, the request may be received from the third-party system 120 for advertising purposes. The visual content generator 230 may generate the virtual TV 620 based on the request and make the virtual TV 620 display an advertisement. In some embodiments, the visual content generator 230 may use the virtual TV 620 for displaying multiple advertisements, such as an advertisement for the TV brand “ABC TV” and another advertisement for the sales at XYZ.com. The two advertisements may be requested by different third-party systems. The visual content generator 230 also makes the virtual TV 620 interactive in the embodiments of FIG. 6. For instance, the text string “CLICK HERE” may be associated with a link to a web page. Upon a user's click of the text string, the user may be directed to the web page.

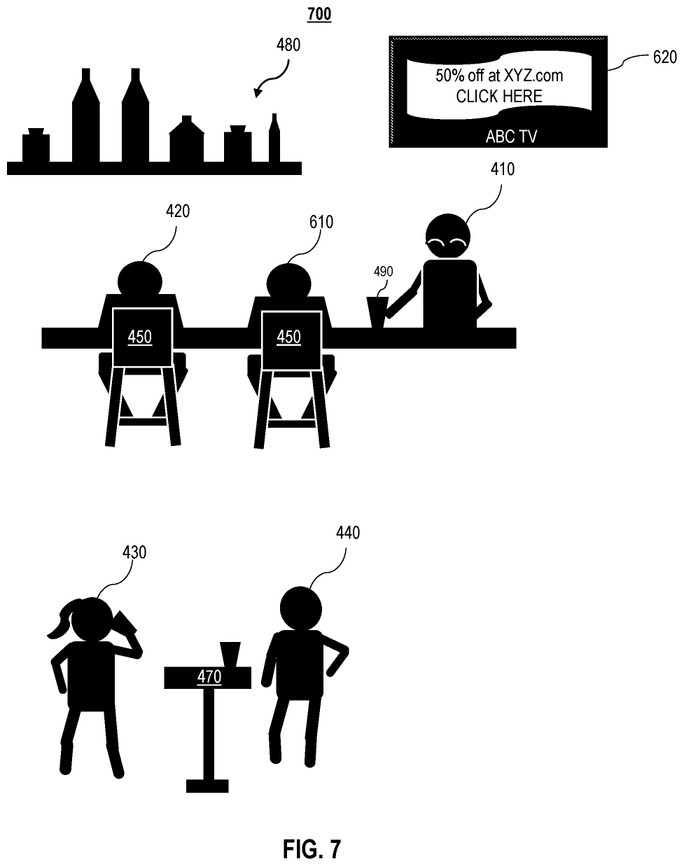

FIG. 7 shows a visual content item 700 having more dimensions than the visual content item 600 in FIG. 6, according to some embodiments of the present disclosure. The visual content item 700 may be generated by the visual content generator 230. For the purpose of illustration, the visual content item 700 is generated by adding a temporal dimension to the visual content item 600. The visual content item 700 has the same objects as the visual content item 600. Different from the visual content item 600 where the person 430 is holding a cup that is placed on the table 470, the person 430 in the visual content item 700 is putting the cup at her mouth and the cup is not on the table 470 anymore. The states of the person 430 and the cup 490 change along the temporal dimension, i.e., as time changes. Even though not shown in FIG. 7, the states of other objects in the visual content item 700 may also change along the temporal dimension. Even though FIG. 7 illustrates the addition of the temporal dimension, the visual content generator 230 may add a spatial dimension to a visual content time to generate a new visual content item. For instance, the visual content generator 230 may convert a 2D visual content item to a 3D visual content item.

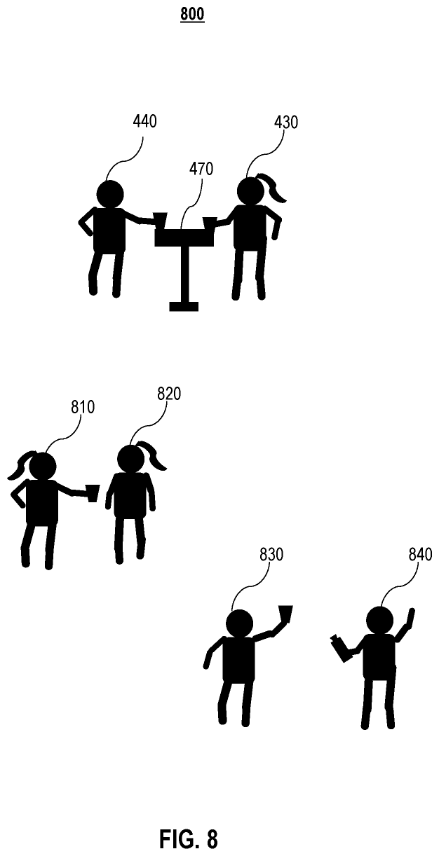

FIG. 8 shows a visual content item 800 having a different viewpoint from the visual content item 400 in FIG. 4, according to some embodiments of the present disclosure. The visual content item 800 may be generated by the visual content generator 230 based on the visual content item 400. For instance, the visual content generator 230 may generate a new viewpoint, e.g., a viewpoint that matches a gaze point of the bartender 410. The visual content generator 230 creates the visual content item 800 to illustrate the perception of the bartender 410 of the scene illustrated by the visual content item 400.

Compared with the visual content item 400, the visual content item 800 also includes the two people 430 and 440, the table 470, and two cups 490 on the table 470. However, the orientations of the two people 430 and 440 and the cups 490 are different given the change of the viewpoint. Also, the visual content item 800 includes objects (e.g., people 810, 820, 830, and 840) that are not present in the visual content item 400. The viewpoint for the visual content item 800 may be a virtual viewpoint. In some embodiments, the visual content item 800 may be associated with multiple viewpoints. For instance, there may be another viewpoint that matches the gate point of the person 430, 440, 810, 820, 830, or 840. The visual content item 800 may facilitate switchable viewpoints so that objects in the visual content item 800 may change as the viewpoint is changed.

### Example Method of Providing Visual Content for Display 10 Users

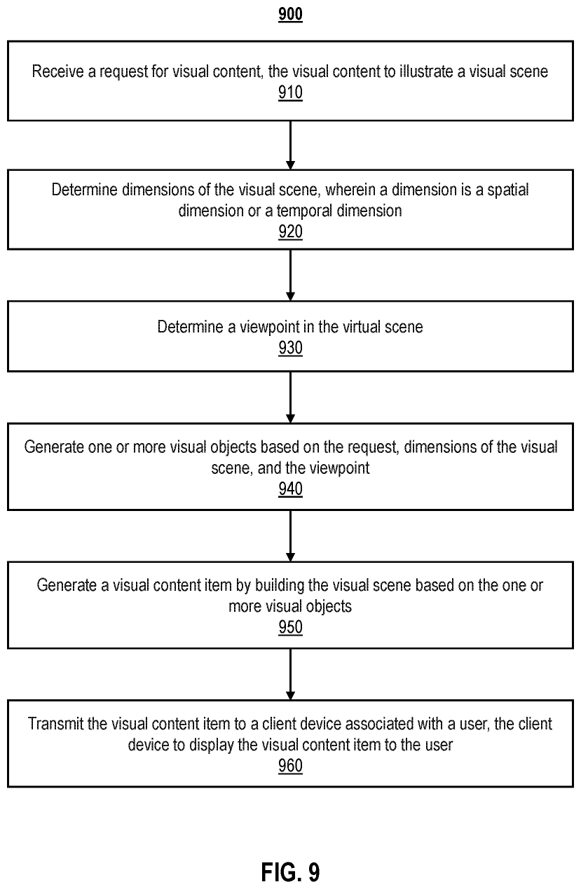

FIG. 9 is a flowchart showing a method 900 of providing visual content items for display to users, according to some embodiments of the present disclosure. The method 900 may be performed by the visual content system 110. Although the method 900 is described with reference to the flowchart illustrated in FIG. 9, many other methods of providing visual content items for display to users may alternatively be used. For example, the order of execution of the steps in FIG. 9 may be changed. As another example, some of the steps may be changed, eliminated, or combined.

The visual content system 110 receives, in 910, a request for visual content. The visual content is to illustrate a visual scene. In some embodiments, visual content system 110 receives the request for visual content from a user associated with a user device 130 or the third-party system 120. The user may be a person who desires to view the visual content. Alternatively, the user may be a person or entity who desires other users to view the visual content.

The visual content system 110 determines, in 920, dimensions of the visual scene, A dimension is a spatial dimension or a temporal dimension. In some embodiments, the request for visual content comprises a different visual content item having two spatial dimensions. The visual content system 110 determines the dimensions of the visual scene by determining three spatial dimensions of the visual scene. The three spatial dimensions comprise the two spatial dimensions of the different visual content item and a new spatial dimension.

The visual content system 110 determines, in 930, a viewpoint in the virtual scene. In some embodiments, the request for visual content comprises a content item that illustrates the visual scene at a first viewpoint. The visual content system 110 determines the viewpoint by changing the first viewpoint to a second viewpoint.

The visual content system 110 generates, in 930, one or more visual objects based on the request, dimensions of the visual scene, and the viewpoint. In some embodiments, the visual content system 110 generates the one or more visual objects by selecting the one or more visual objects from a plurality of candidate visual objects. The plurality of candidate visual objects is generated before the request for visual content is generated.

In some embodiments, the request for visual content comprises a content item, such as a textual document, etc. The visual content system 110 generates the one or more visual objects by determining a theme of the virtual scene by analyzing the content item and generating the one or more visual objects based on the theme of the virtual scene. In some embodiments, the request for visual content is received from the user. The one or more visual objects comprises a graphical representation (e.g., an avatar) of the user.

The visual content system 110 generates, in 940, a visual content item by building the visual scene based on the one or more visual objects. In some embodiments, the one or more visual objects comprises a visual object that is interactive. The visual content system 110 provides a user interface that allows the user to interact with the visual object.

The visual content system 110 transmits, in 950, the visual content item to a client device associated with a user, the client device to display the visual content item to the user.

In some embodiments, the visual content system 110 receives the request for visual content from another client device associated with another user that is different from the user to whom the visual content is to be provided for display. In some embodiments, the other user is associated with an online system that provides one or more online items for display to the user. The visual content system 110 generates the one or more visual objects by generating the one or more visual objects based on an interaction of the user with the one or more online items. In some embodiments, the visual content system 110 receives information of the interaction of the user with the one or more online items from the online system associated with the other user.

### Example Computing Device

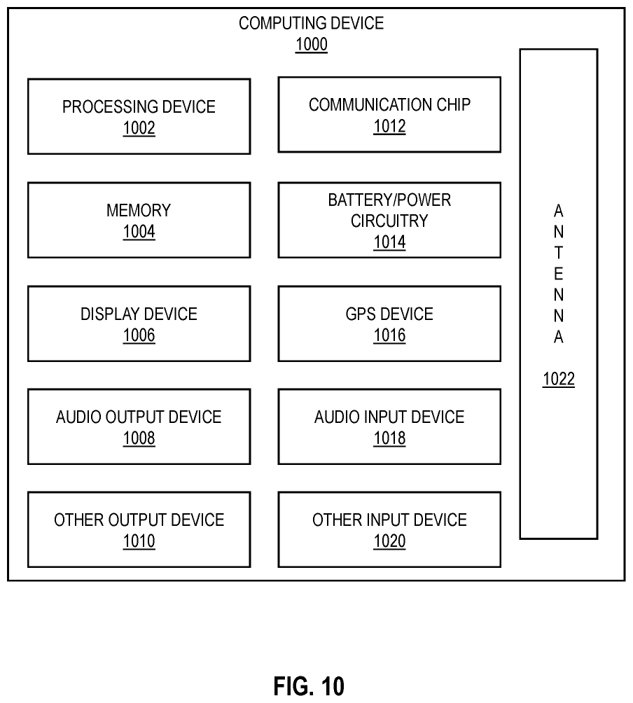

FIG. 10 is a block diagram of an exemplary computing device 1000, according to some embodiments of the disclosure. One or more computing devices 1000 may be used to implement the functionalities described hereinabove, such as functions of the visual content system 110. A number of components are illustrated in FIG. 10 as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations for generating and providing visual content items, such as the method 900 illustrated in FIG. 9 or some operations performed by the visual content system 110 described above in conjunction with FIGS. 1-3. Exemplary parts that may be encoded as instructions and stored in memory 1004 are depicted. Memory 1004 may store instructions that encode one or more exemplary parts. The instructions stored in the one or more non-transitory computer-readable media may be executed by processing device 1002. In some embodiments, memory 1004 may store data, e.g., data structures, binary data, bits, metadata, files, blobs, etc. Exemplary data that may be stored in memory 1004 are depicted. Memory 1004 may store one or more data as depicted.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1000 may be any other electronic device that processes data.

### Select Examples

Example 1 provides a method, including receiving a request for visual content, the visual content to illustrate a visual scene; determining dimensions of the visual scene, where a dimension is a spatial dimension or a temporal dimension; determining a viewpoint in the visual scene; generating one or more visual objects based on the request, dimensions of the visual scene, and the viewpoint; generating a visual content item by building the visual scene based on the one or more visual objects; and transmitting the visual content item to a client device associated with a user, the client device to display the visual content item to the user.

Example 2 provides the method of example 1, where the request for visual content includes a different visual content item having two spatial dimensions, and determining the dimensions of the visual scene includes determining three spatial dimensions of the visual scene, the three spatial dimensions including the two spatial dimensions of the different visual content item and a new spatial dimension.

Example 3 provides the method of example 1 or 2, where generating the one or more visual objects includes selecting the one or more visual objects from a plurality of candidate visual objects, where the plurality of candidate visual objects is generated before the request for visual content is generated.

Example 4 provides the method of any one of examples 1-3, where receiving the request for visual content includes receiving the request for visual content from another client device associated with another user that is different from the user.

Example 5 provides the method of example 4, where the other user is associated with an online system that provides one or more online items for display to the user, and generating the one or more visual objects includes generating the one or more visual objects based on an interaction of the user with the one or more online items.

Example 6 provides the method of example 5, further includes receiving information of the interaction of the user with the one or more online items from the online system associated with the other user.

Example 7 provides the method of any one of examples 1-6, where the request for visual content includes a content item, and generating the one or more visual objects includes determining a theme of the visual scene by analyzing the content item; and generating the one or more visual objects based on the theme of the visual scene.

Example 8 provides the method of any one of examples 1-7, where: the request for visual content includes a content item that illustrates the visual scene at a first viewpoint, determining the viewpoint includes changing the first viewpoint to a second viewpoint, and generating the one or more visual objects includes generating the one or more visual objects based on the second viewpoint.

Example 9 provides the method of any one of examples 1-8. where the request for visual content is received from the user, the one or more visual objects includes a graphical representation of the user, and the viewpoint is a viewpoint of the graphical representation of the user.

Example 10 provides the method of any one of examples 1-9, where the one or more visual objects includes a visual object that is interactive, and the method further includes providing a user interface that allows the user to interact with the visual object.

Example 11 provides one or more non-transitory computer-readable media storing instructions executable to perform operations, the operations including receiving a request for visual content, the visual content to illustrate a visual scene; determining dimensions of the visual scene, where a dimension is a spatial dimension or a temporal dimension; determining a viewpoint in the visual scene; generating one or more visual objects based on the request, dimensions of the visual scene, and the viewpoint; generating a visual content item by building the visual scene based on the one or more visual objects; and transmitting the visual content item to a client device associated with a user, the client device to display the visual content item to the user.

Example 12 provides the one or more non-transitory computer-readable media of example 11, where the request for visual content includes a different visual content item having two spatial dimensions, and determining the dimensions of the visual scene includes determining three spatial dimensions of the visual scene, the three spatial dimensions including the two spatial dimensions of the different visual content item and a new spatial dimension.

Example 13 provides the one or more non-transitory computer-readable media of example 11 or 12, where generating the one or more visual objects includes selecting the one or more visual objects from a plurality of candidate visual objects, where the plurality of candidate visual objects is generated before the request for visual content is generated.

Example 14 provides the one or more non-transitory computer-readable media of any one of examples 11-13, where receiving the request for visual content includes receiving the request for visual content from another client device associated with another user that is different from the user.

Example 15 provides the one or more non-transitory computer-readable media of example 14, where the other user is associated with an online system that provides one or more online items for display to the user, and generating the one or more visual objects includes generating the one or more visual objects based on an interaction of the user with the one or more online items.

Example 16 provides the one or more non-transitory computer-readable media of example 15, further includes receiving information of the interaction of the user with the one or more online items from the online system associated with the other user.

Example 17 provides the one or more non-transitory computer-readable media of any one of examples 11-16, where the request for visual content includes a content item, and generating the one or more visual objects includes determining a theme of the visual scene by analyzing the content item; and generating the one or more visual objects based on the theme of the visual scene.

Example 18 provides the one or more non-transitory computer-readable media of any one of examples 11-17, where: the request for visual content includes a content item that illustrates the visual scene at a first viewpoint, determining the viewpoint includes changing the first viewpoint to a second viewpoint, and generating the one or more visual objects includes generating the one or more visual objects based on the second viewpoint.

Example 19 provides an apparatus, including a computer processor for executing computer program instructions; and a non-transitory computer-readable memory storing computer program instructions executable by the computer processor to perform operations including receiving a request for visual content, the visual content to illustrate a visual scene, determining dimensions of the visual scene, where a dimension is a spatial dimension or a temporal dimension, determining a viewpoint in the visual scene, generating one or more visual objects based on the request, dimensions of the visual scene, and the viewpoint, generating a visual content item by building the visual scene based on the one or more visual objects, and transmitting the visual content item to a client device associated with a user, the client device to display the visual content item to the user.

Example 20 provides the apparatus of example 19, where the request for visual content includes a different visual content item having two spatial dimensions, and determining the dimensions of the visual scene includes determining three spatial dimensions of the visual scene, the three spatial dimensions including the two spatial dimensions of the different visual content item and a new spatial dimension.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of DSPs, microprocessors, supporting chipsets, etc.). computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along with similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

What is claimed is:

1. A method, comprising:
receiving a request for visual content, the visual content to illustrate a visual scene;
determining dimensions of the visual scene, wherein a dimension is a spatial dimension or a temporal dimension;
determining a viewpoint in the visual scene;
generating one or more visual objects based on the request, dimensions of the visual scene, and the viewpoint;
generating a visual content item by building the visual scene based on the one or more visual objects; and
transmitting the visual content item to a client device associated with a user, the client device to display the visual content item to the user.

2. The method of claim 1, wherein the request for visual content comprises a different visual content item having two spatial dimensions, and determining the dimensions of the visual scene comprises:
determining three spatial dimensions of the visual scene, the three spatial dimensions comprising the two spatial dimensions of the different visual content item and a new spatial dimension.

3. The method of claim 1, wherein generating the one or more visual objects comprises:
selecting the one or more visual objects from a plurality of candidate visual objects, wherein the plurality of candidate visual objects is generated before the request for visual content is generated.

4. The method of claim 1, wherein receiving the request for visual content comprises:
receiving the request for visual content from another client device associated with another user that is different from the user.

5. The method of claim 4, wherein the other user is associated with an online system that provides one or more online items for display to the user, and generating the one or more visual objects comprises:
generating the one or more visual objects based on an interaction of the user with the one or more online items.

6. The method of claim 5, further comprises:
receiving information of the interaction of the user with the one or more online items from the online system associated with the other user.

7. The method of claim 1, wherein the request for visual content comprises a content item, and generating the one or more visual objects comprises:
determining a theme of the visual scene by analyzing the content item; and
generating the one or more visual objects based on the theme of the visual scene.

8. The method of claim 1, wherein:
the request for visual content comprises a content item that illustrates the visual scene at a first viewpoint,
determining the viewpoint comprises changing the first viewpoint to a second viewpoint, and
generating the one or more visual objects comprises generating the one or more visual objects based on the second viewpoint.

9. The method of claim 1, wherein the request for visual content is received from the user, the one or more visual objects comprises a graphical representation of the user, and the viewpoint is a viewpoint of the graphical representation of the user.

10. The method of claim 1, wherein the one or more visual objects comprises a visual object that is interactive, and the method further comprises:
providing a user interface that allows the user to interact with the visual object.

11. One or more non-transitory computer-readable media storing instructions executable to perform operations, the operations comprising:
receiving a request for visual content, the visual content to illustrate a visual scene;
determining dimensions of the visual scene, wherein a dimension is a spatial dimension or a temporal dimension;
determining a viewpoint in the visual scene;
generating one or more visual objects based on the request, dimensions of the visual scene, and the viewpoint;
generating a visual content item by building the visual scene based on the one or more visual objects; and
transmitting the visual content item to a client device associated with a user, the client device to display the visual content item to the user.

12. The one or more non-transitory computer-readable media of claim 11, wherein the request for visual content comprises a different visual content item having two spatial dimensions, and determining the dimensions of the visual scene comprises:
determining three spatial dimensions of the visual scene, the three spatial dimensions comprising the two spatial dimensions of the different visual content item and a new spatial dimension.

13. The one or more non-transitory computer-readable media of claim 11, wherein generating the one or more visual objects comprises:
selecting the one or more visual objects from a plurality of candidate visual objects, wherein the plurality of candidate visual objects is generated before the request for visual content is generated.

14. The one or more non-transitory computer-readable media of claim 11, wherein receiving the request for visual content comprises:
receiving the request for visual content from another client device associated with another user that is different from the user.

15. The one or more non-transitory computer-readable media of claim 14, wherein the other user is associated with an online system that provides one or more online items for display to the user, and generating the one or more visual objects comprises:
generating the one or more visual objects based on an interaction of the user with the one or more online items.

16. The one or more non-transitory computer-readable media of claim 15, further comprises:
receiving information of the interaction of the user with the one or more online items from the online system associated with the other user.

17. The one or more non-transitory computer-readable media of claim 11, wherein the request for visual content comprises a content item, and generating the one or more visual objects comprises:
determining a theme of the visual scene by analyzing the content item; and
generating the one or more visual objects based on the theme of the visual scene.

18. The one or more non-transitory computer-readable media of claim 11, wherein:
the request for visual content comprises a content item that illustrates the visual scene at a first viewpoint,
determining the viewpoint comprises changing the first viewpoint to a second viewpoint, and
generating the one or more visual objects comprises generating the one or more visual objects based on the second viewpoint.

19. An apparatus, comprising:
a computer processor for executing computer program instructions; and
a non-transitory computer-readable memory storing computer program instructions executable by the computer processor to perform operations comprising:
receiving a request for visual content, the visual content to illustrate a visual scene,
determining dimensions of the visual scene, wherein a dimension is a spatial dimension or a temporal dimension,
determining a viewpoint in the visual scene,
generating one or more visual objects based on the request, dimensions of the visual scene, and the viewpoint,
generating a visual content item by building the visual scene based on the one or more visual objects, and
transmitting the visual content item to a client device associated with a user, the client device to display the visual content item to the user.

20. The apparatus of claim 19, wherein the request for visual content comprises a different visual content item having two spatial dimensions, and determining the dimensions of the visual scene comprises:
determining three spatial dimensions of the visual scene, the three spatial dimensions comprising the two spatial dimensions of the different visual content item and a new spatial dimension.
